(19) United States
(12) Patent Application Publication
(10) Pub. No.: US 2016/0102701 A1
(43) Pub. Date: Apr. 14, 2016

(54) SYSTEMS AND METHODS FOR PROVIDING A DYNAMIC AND RESILIENT LOAD BEARING ACCESSORY ORGANIZER

(71) Applicant: JAIME N. CAPENER, BOUNTIFUL, UT (US)

(72) Inventor: JAIME N. CAPENER, BOUNTIFUL, UT (US)

(21) Appl. No.: 14/879,947

(22) Filed: Oct. 9, 2015

Related U.S. Application Data
(60) Provisional application No. 62/062,819, filed on Oct. 10, 2014.

(51) Int. Cl. F16B 45/00; F16M 13/02

(52) U.S. Cl. CPC F16B 45/00; F16M 13/022

(57) ABSTRACT

Organizational structures that can be hung from a fixed surface, each organizational structure having a rod that is configured to have a plurality of radii, such that the structure has a first radius that is configured to be coupled to a fixed surface and one or more other radii configured to provide support for one or more items can be hung/draped on and supported by the structure. In further implementations, the organizational structure includes one or more add-on structures and/or other supporting structures or surfaces that add an additional layer, attribute or feature of organization to the overall system.

### 1. RELATED APPLICATIONS

This application claims priority to U.S. Provisional Patent Application Ser. No. 62/062,819 filed Oct. 10, 2014, entitled SYSTEMS AND METHODS FOR PROVIDING A DYNAMIC AND RESILIENT LOAD BEARING ACCESSORY ORGANIZER, which is incorporated herein by reference.

### BACKGROUND OF THE INVENTION

1. Field of the Invention

The present invention relates to providing an accessory organizer. In particular, the present invention relates to systems and methods for providing a load bearing accessory organizer that is dynamic, versatile and resilient.

2. Background and Related Art

Closets are commonly used for storage. Such closets can be built into the walls of a house during construction or can be a free-standing piece of furniture designed for storing clothing or other items. Some closets are built in an awkward space, such as under a set of stairs, which otherwise could go unused.

A variety of techniques are currently available to organize a closet. Some techniques include shelves, racks, boxes, and/or storage bins. Other techniques include complex structures that utilize gears and motors. Some closet organizers are fully integrated shelving systems that are constructed within the closet. However, such shelving systems are difficult to install without professional help, are expensive as customization increases, are fixed structures, and/or are limited on the amount of weight they can hold.

Thus, while techniques currently exist that are used to organize closets, challenges still exist. Accordingly, it would be an improvement in the art to augment or even replace current techniques with other techniques.

### SUMMARY OF THE INVENTION

The present invention relates to providing an accessory organizer. In particular, the present invention relates to systems and methods for providing a load bearing accessory organizer that is dynamic, versatile and resilient.

Implementation of the present invention takes place in association with a structure that can be hung from a fixed surface. In some implementations, the structure includes a single anodized aluminum rod that is curved, shaped or otherwise configured to have a plurality of radii. In some implementations, the structure has a first radius that is configured to be hung from or otherwise coupled to a fixed surface and one or more other radii configured to provide support for clothing, accessories, supplies, and/or any other item that can be hung/draped on and supported by the structure. In some implementations, the structure radius that is configured to be coupled to a fixed surface is removably coupled to the fixed surface such that it can be selectively coupled to any of a variety of fixed surfaces. In some implementations, the structure radius that is configured to be coupled to a fixed surface is fixedly coupled to the fixed surface.

At least some implementations of the present invention are highly configurable, inexpensive, aesthetically pleasing, and versatile. In some implementations, the structure includes an assortment of add-ons, attachments, and/or other additional supporting structures or surfaces that add an additional layer, attribute or feature of organization. Such attachments are generally coupled to the structure, such as by being threaded onto the organization structure. Further a plurality of the organizational structures are configured to be selectively used in tandem to create further structures that maximize space and create additional surface area. Accordingly, implementations of the present invention can be used as a single unit to hang or drape clothing, accessories, supplies, and/or other items, can be used in a series of single units to organize and store clothing, accessories, supplies, and/or other items by style, type, color, or any other organizational categorization, or can be used in a networked structure of units that optimally utilize available space.

Thus, at least some implementations of the present invention provide a system that can organize clothing, accessories, supplies, and/or other items in a variety of configurations while maintaining portability, aesthetics, versatility, resiliency, and effective use of space. Implementations of the present invention can be utilized in virtually any situation in which the system can be hung, and can maximize storage space by creating additional surface area in which items are selectively hung or otherwise draped.

While the methods and processes of the present invention have proven to be particularly useful in the area of closet organization, those skilled in the art can appreciate that the methods and processes can be used in a variety of different applications and in a variety of different areas of manufacture to organize one or more items in a variety of configurations while maintaining portability, aesthetics, versatility, resiliency, and effective use of space.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a side view of a representative organizational structure;

FIG. 2 illustrates other representative organizational structures;

FIG. 3 illustrates yet other representative organizational structures;

FIG. 4 illustrates a series of organizational structures used in a closet environment;

FIG. 5 illustrates a single organizational structure supporting a variety of items;

FIG. 6 illustrates an organizational structure supporting a plurality of items;

FIG. 7 illustrates another organizational structure supporting a plurality of items;

FIG. 8 illustrates an organizational structure used in a shower environment;

FIG. 9 illustrates a plurality of organizational structures used in a system to provide increased surface area for supporting items;

FIG. 10 illustrates another representation of a plurality of organizational structures used in a system to provide increased surface area for supporting items;

FIG. 11 illustrates yet another representation of a plurality of organizational structures used in a system to provide increased surface area for supporting items;

FIG. 12 illustrates an organizational structure in association with a plurality of add-ons that provide additional features to the organizational system;

FIG. 13 illustrates another organizational structure in association with a plurality of add-ons that provide additional features to the organizational system for supporting items;

FIG. 14 illustrates yet another organizational structure in association with a plurality of add-ons that provide additional features to the organizational system for supporting items;

FIG. 15 illustrates another organizational structure in association with an attachment that provides one or more additional attributes to the organizational system for supporting items; and

FIG. 16 illustrates a representative organizational structures used in a representative environment.

### DETAILED DESCRIPTION OF THE INVENTION

The present invention relates to providing an accessory organizer. In particular, the present invention relates to systems and methods for providing a load bearing accessory organizer that is dynamic, versatile and resilient.

Embodiments of the present invention take place in association with a structure that can be hung from a fixed surface. In some embodiments, the structure includes a single anodized aluminum rod that is curved, shaped or otherwise configured to have a plurality of radii. In some embodiments, the structure has a first radius that is configured to be hung from or otherwise coupled to a fixed surface and one or more other radii configured to provide support for clothing (including wet clothing and swimsuits), accessories (e.g., belts, scarves, handbags, jewelry, shoelaces, etc.), supplies (e.g., pet leashes, pet toys, a loofah, towels, wash clothes, sheets, diaper bags, baby supplies, etc.), and/or any other item that can be hung/draped on and supported by the structure. Further examples of such items include clothing, In some embodiments, the structure radius that is configured to be coupled to a fixed surface is removably coupled to the fixed surface such that it can be selectively coupled to any of a variety of fixed surfaces. In some embodiments, the structure radius that is configured to be coupled to a fixed surface is fixedly coupled to the fixed surface.

At least some embodiments of the present invention are highly configurable, inexpensive, aesthetically pleasing, and versatile. In some embodiments, the structure includes an assortment of add-ons, attachments, and/or other additional supporting structures or surfaces that add an additional layer, attribute or feature of organization. Such attachments are generally coupled to the structure, such as by being threaded onto the organization structure. Further, a plurality of the organizational structures are configured to be selectively used in tandem to create further structures that maximize space and create additional surface area. Accordingly, embodiments of the present invention can be used as a single unit to hang or drape clothing, accessories, supplies, and/or other items, can be used in a series of single units to organize and store clothing, accessories, supplies, and/or other items by style, type, color, or any other organizational categorization, or can be used in a networked structure of units that optimally utilize available space.

Thus, at least some embodiments of the present invention provide a system that can organize clothing, accessories, supplies, and/or other items in a variety of configurations while maintaining portability, aesthetics, versatility, resiliency, and effective use of space. Embodiments of the present invention can be utilized in virtually any situation in which the system can be hung, and can maximize storage space by creating additional surface area in which items are selectively hung or otherwise draped.

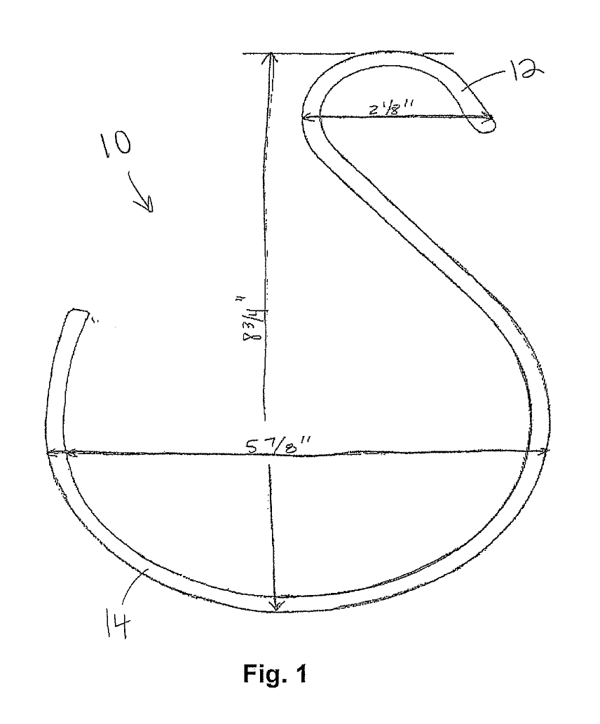

With reference now to FIG. 1, a side view of a representative organizational structure is illustrated. As provided herein, embodiments of the present invention take place in association with a structure that can be hung from a fixed surface. In some embodiments, the structure includes a single rod comprised of anodized aluminum, a polymer, a metal, steel, titanium, an alloy, a composite, hardened rubber, graphene, coated graphene, and/or any other suitable material that is curved, shaped or otherwise configured to have a plurality of radii. In some embodiments, the anodized aluminum rod is extruded through a die and one or more radii are formed.

In the illustrated embodiment of FIG. 1, organizational structure 10 includes coupling structure 12 having a first radius and supporting structure 14 having a second radius. Coupling structure 12 is configured to be hung from or otherwise coupled to a fixed surface. In the illustrated embodiment, organizational structure 10 specifically comprises a unitary piece of one eighth inch (⅛″) anodized aluminum rod arranged in a configuration having coupling structure 12 and supporting structure 14, such that coupling structure 12 and supporting structure 14 have non-identical shapes and/or sizes. In the illustrated embodiment of FIG. 1, coupling structure 12 has a representative width of approximately two and one eighth inches (2⅛ inches) to allow for coupling to a standard closet bar. In the illustrated embodiment, supporting structure 14 has a representative width of approximately five and seven eighth inches (5⅞ inches). The total vertical height of the illustrated embodiment is eight and three quarter inches (8¾ inches).

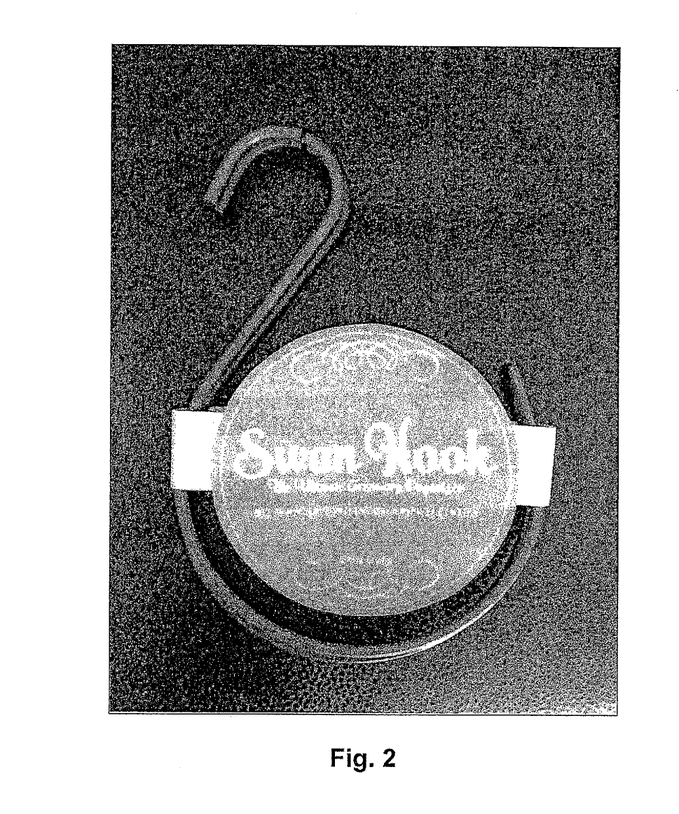

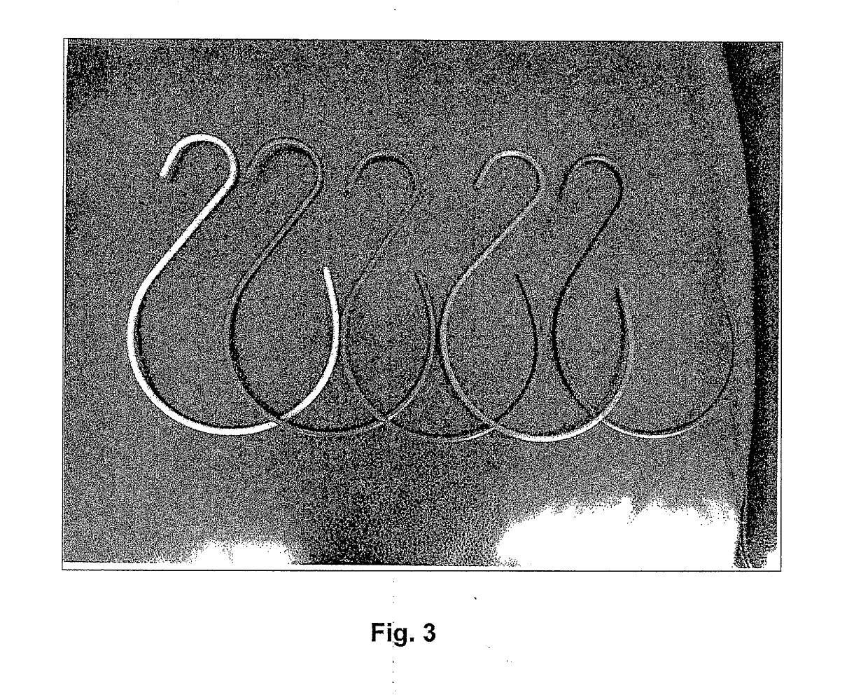

Those skilled in the art will appreciate that while the representative embodiment of FIG. 1 provides the specific shapes, configuration, and dimensions as illustrated, other embodiments of the present invention embrace other shapes, sizes, configurations and/or dimensions. Therefore, the shapes, sizes, configurations and/or dimensions can be modified to accommodate the particular needs of the user. For example, some hotels and other guest lodging services utilize a coupling structure with a smaller dimension to prevent theft of the component and to accommodate the smaller closet rods of the hotel. Further, in some embodiments, the coupling structure is formed such that it cannot be removed from the closet rod to prevent removal by the user. In some embodiments, a thicker gauge is utilized for organizing heavier items such as tools (e.g., wrenches, hand tools, utility lights, power tools, etc.), household supplies, (e.g., lawn chairs, bird houses, planters, barbeque accessories, brushes, spatulas, extension cords, Christmas lights, etc.), industrial supplies and/or to reduce creases of more delicate materials such as wools and silk. FIGS. 2-3 illustrate other representative organizational structures, wherein the structures can be used alone or in combination.

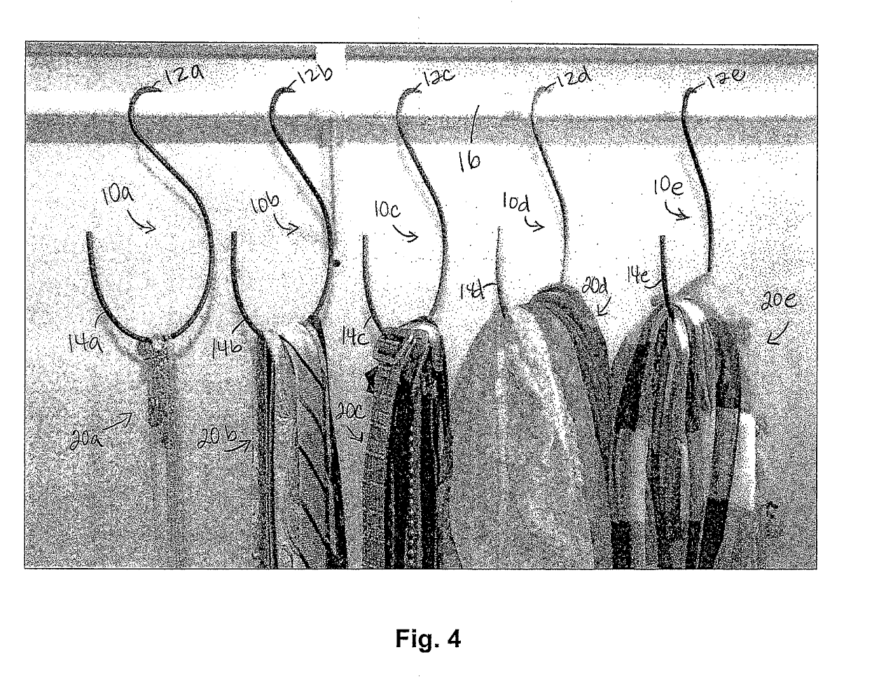

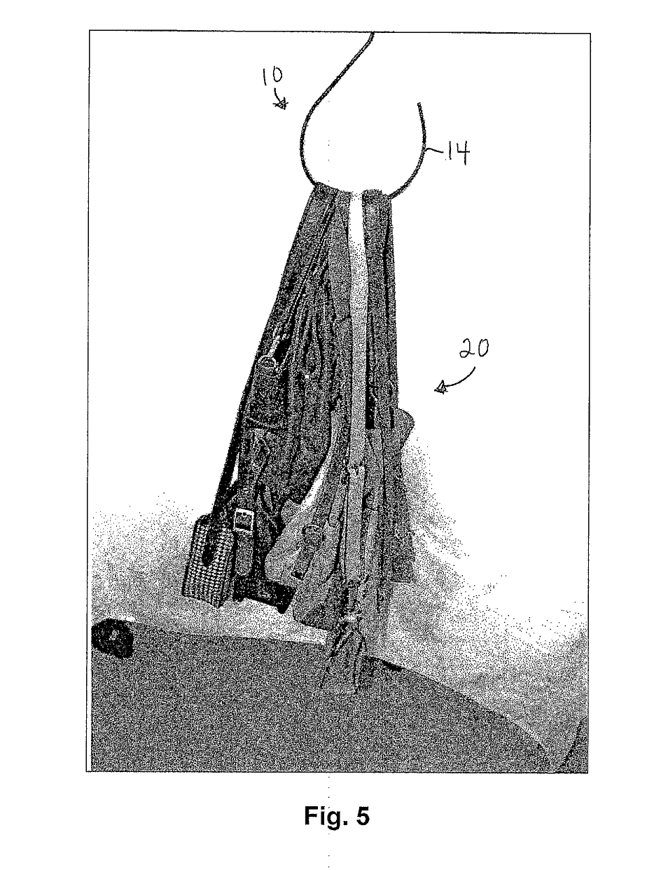

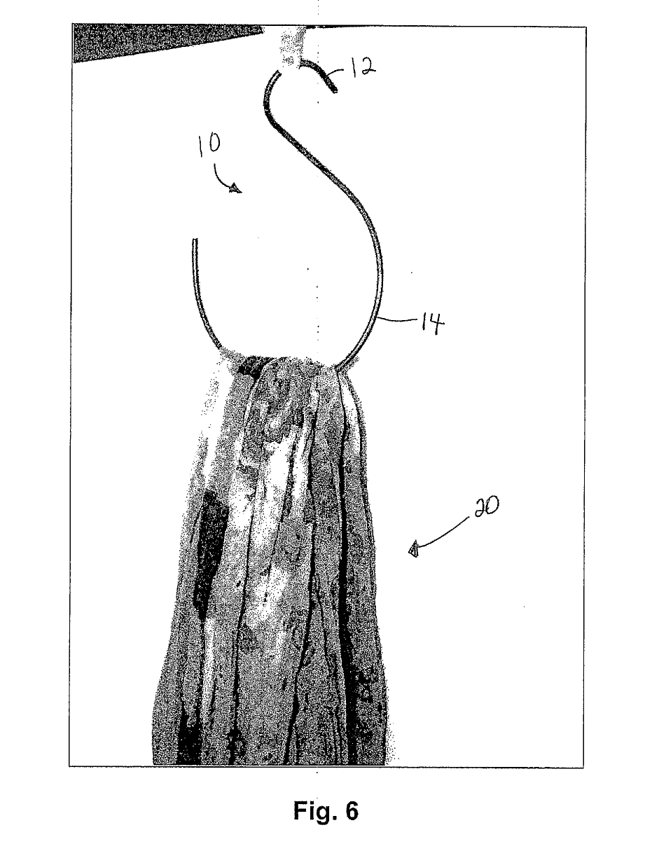

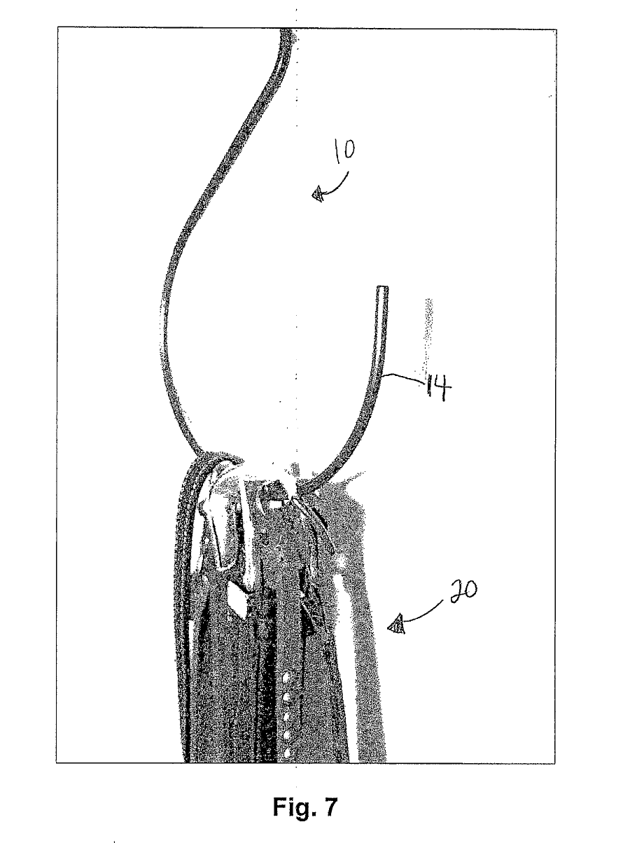

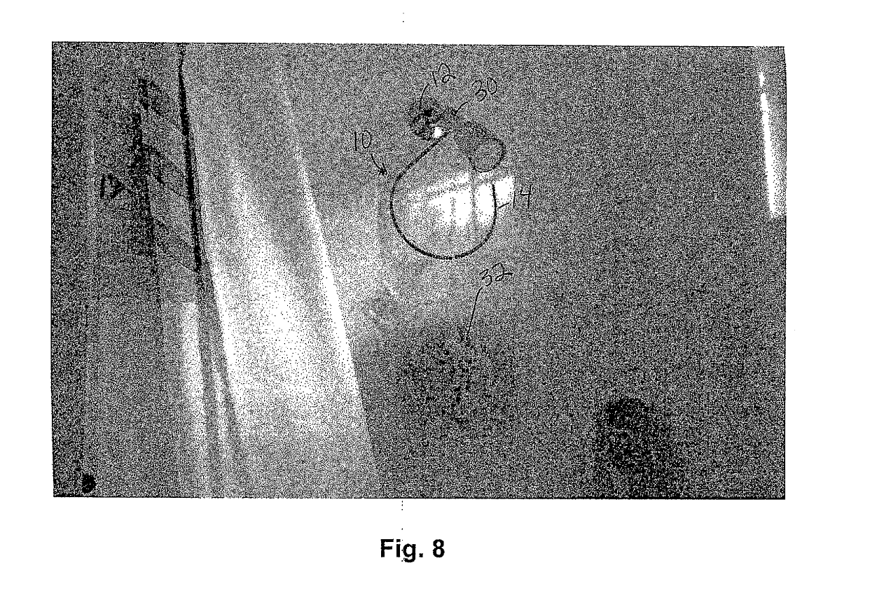

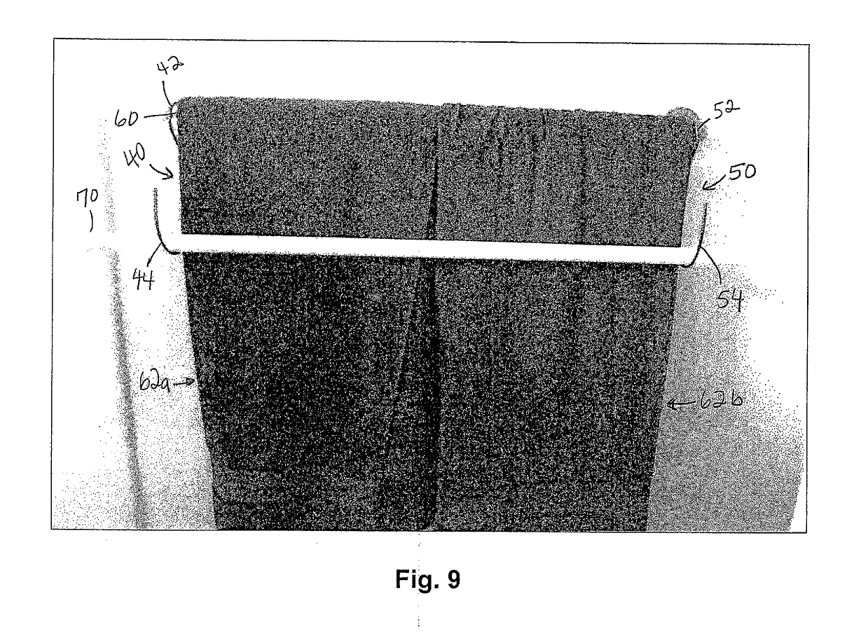

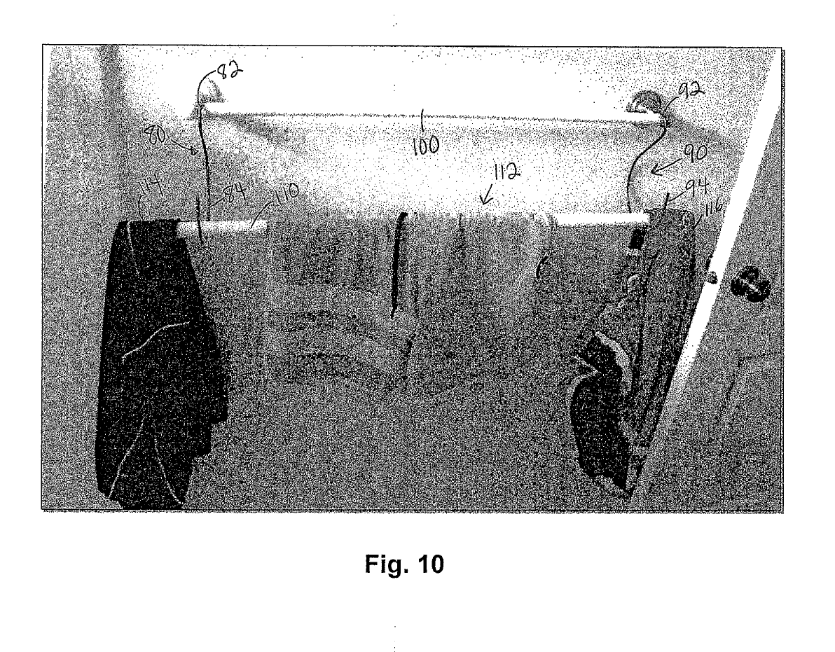

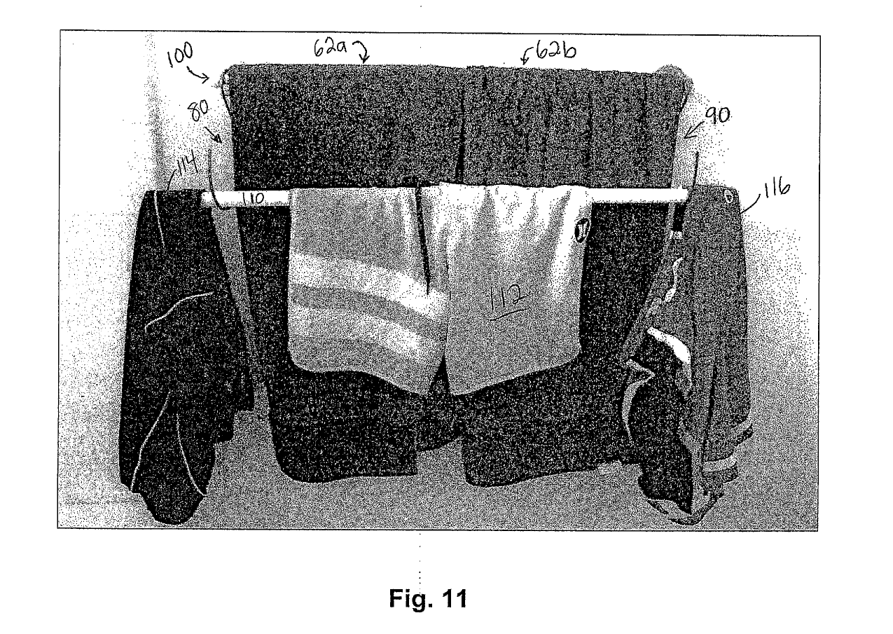

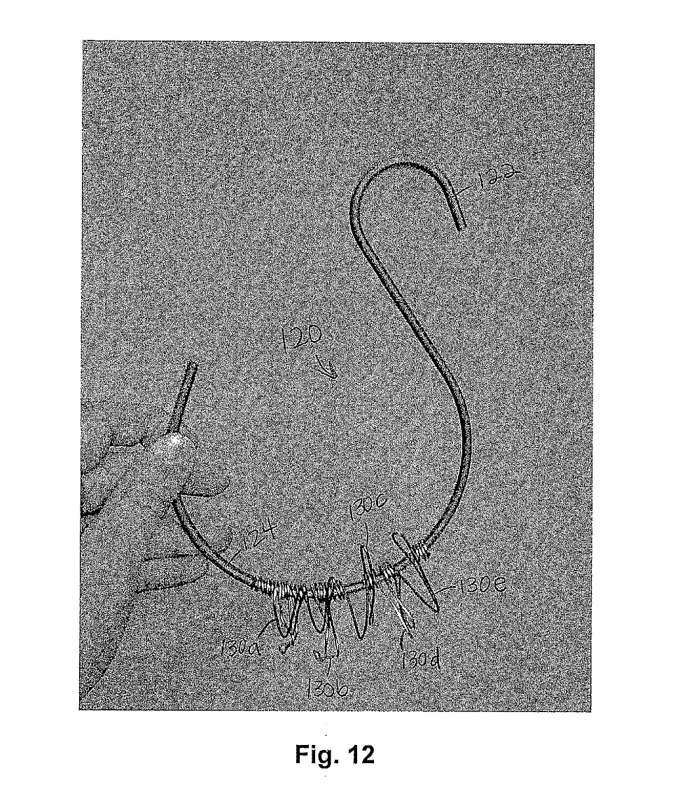

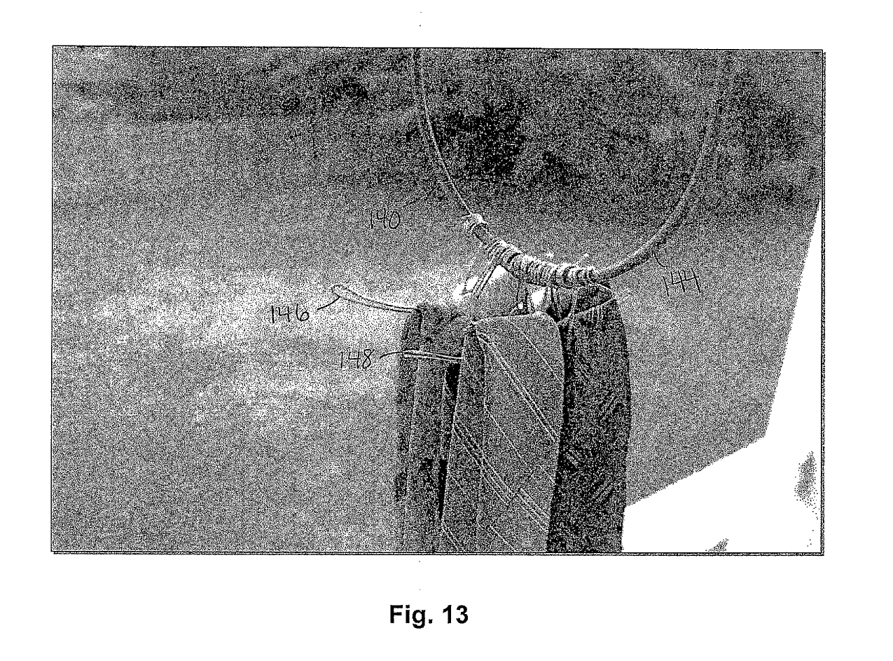

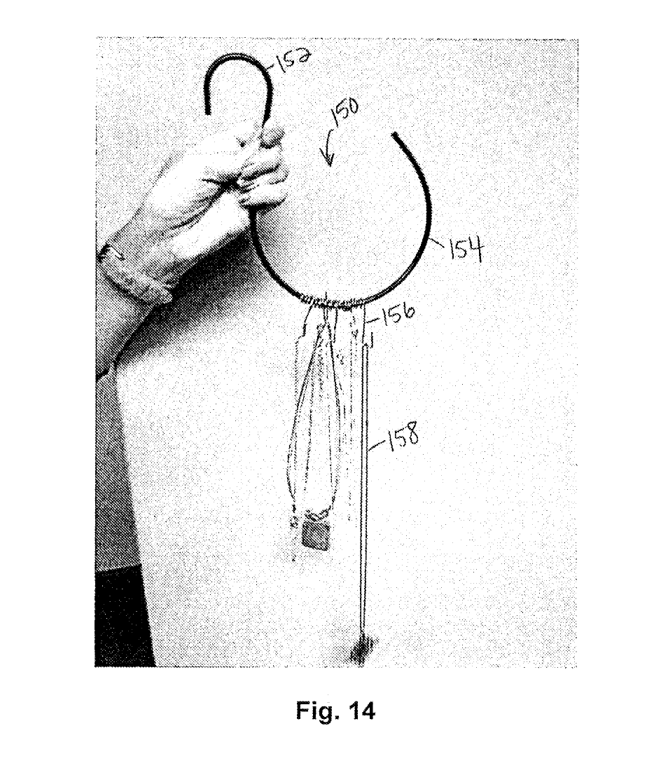

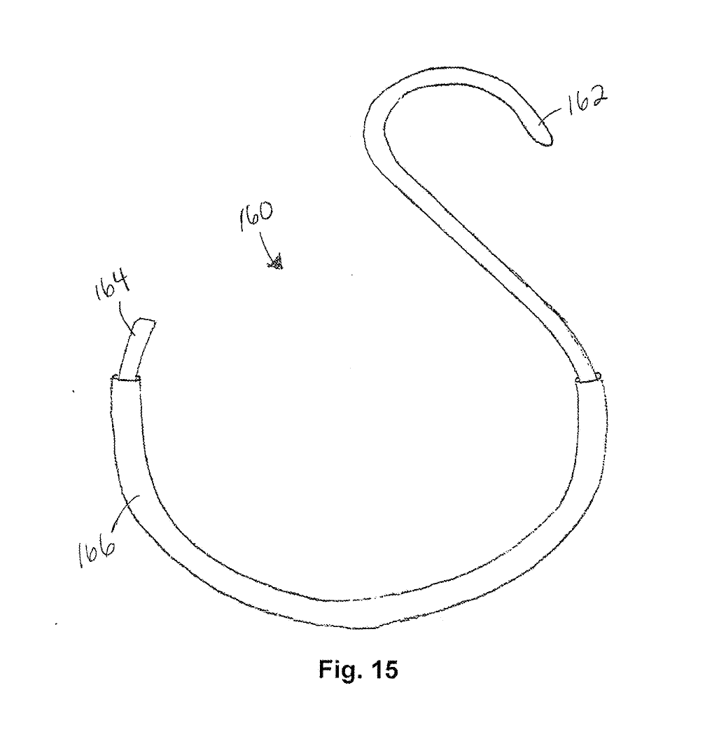

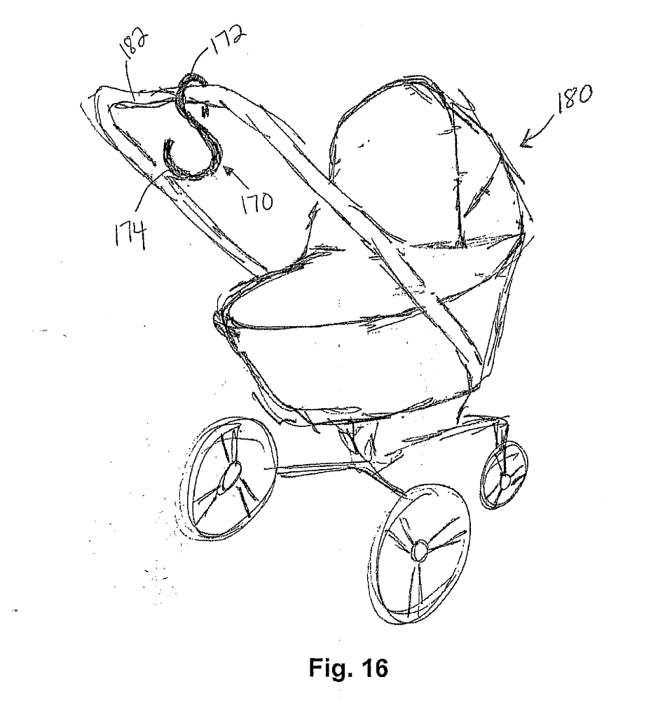

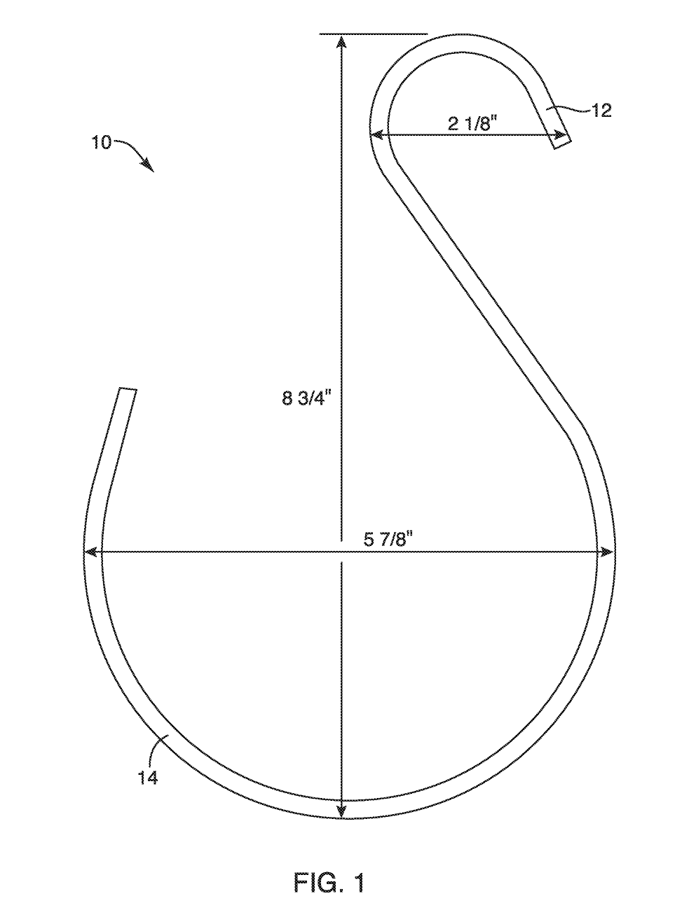

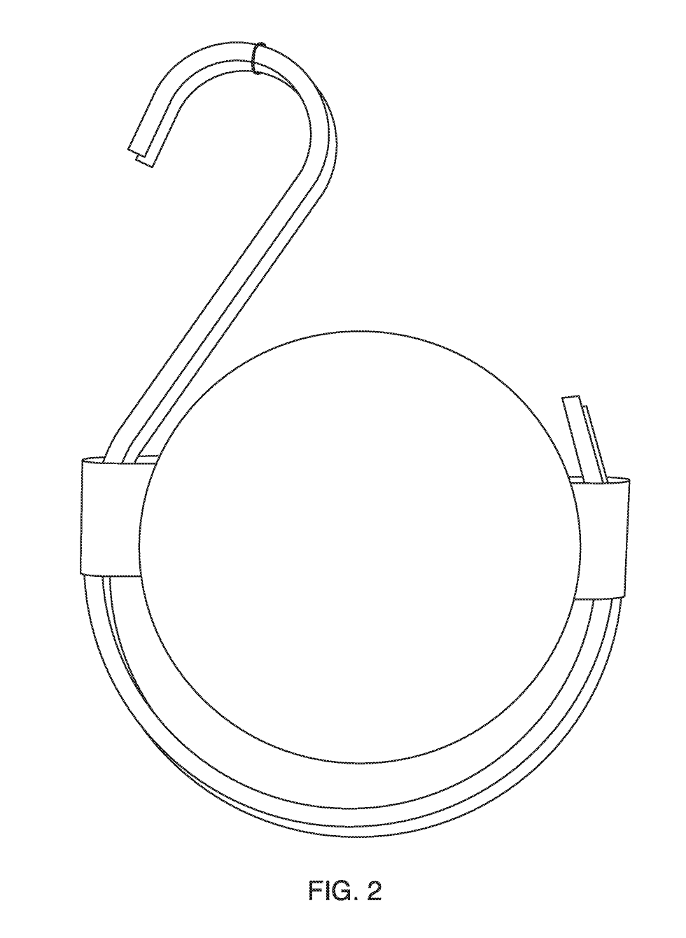

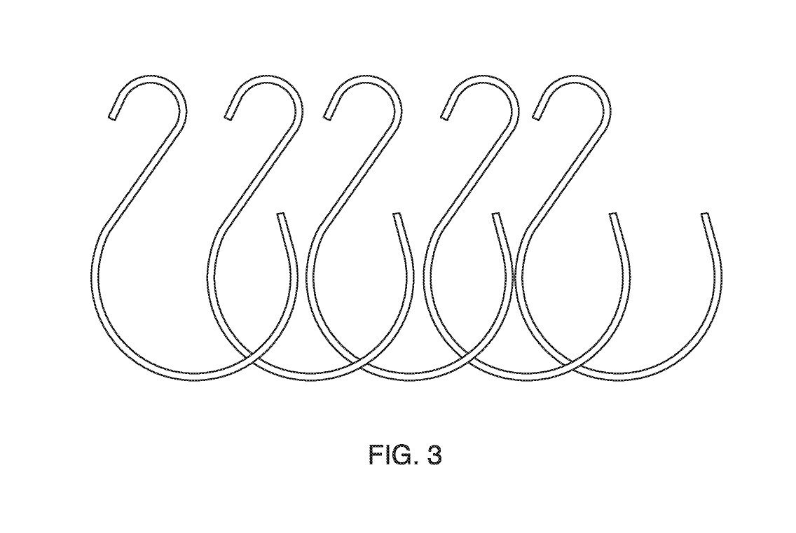

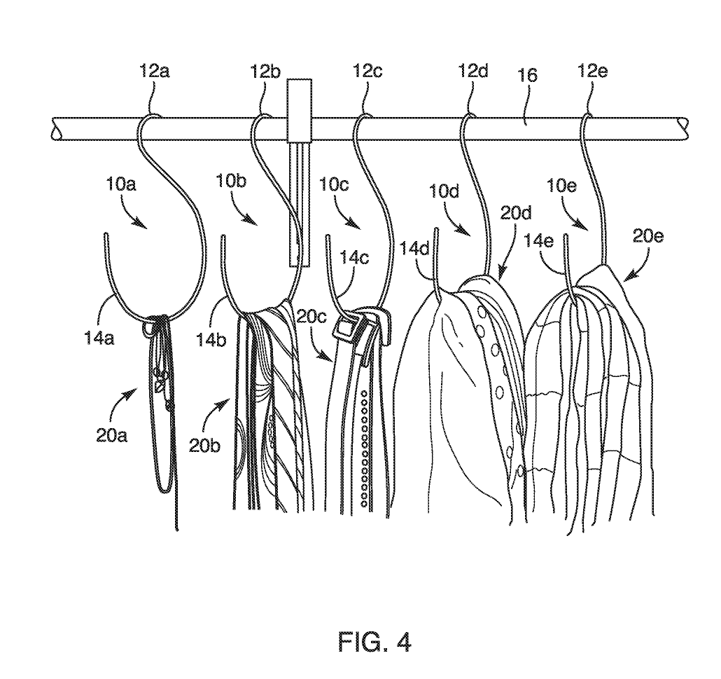

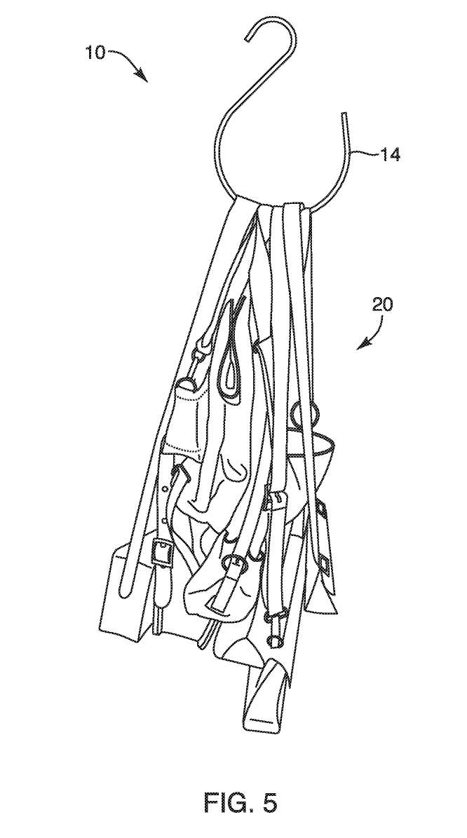

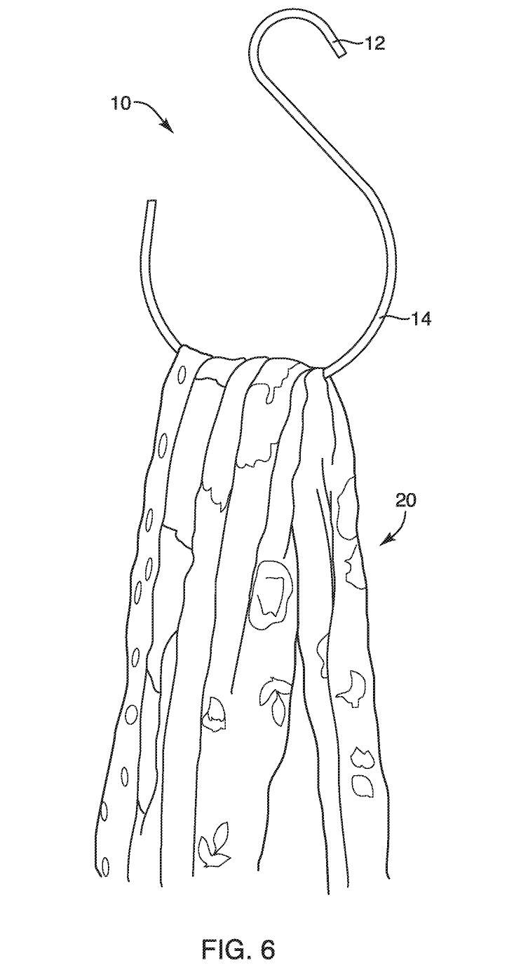

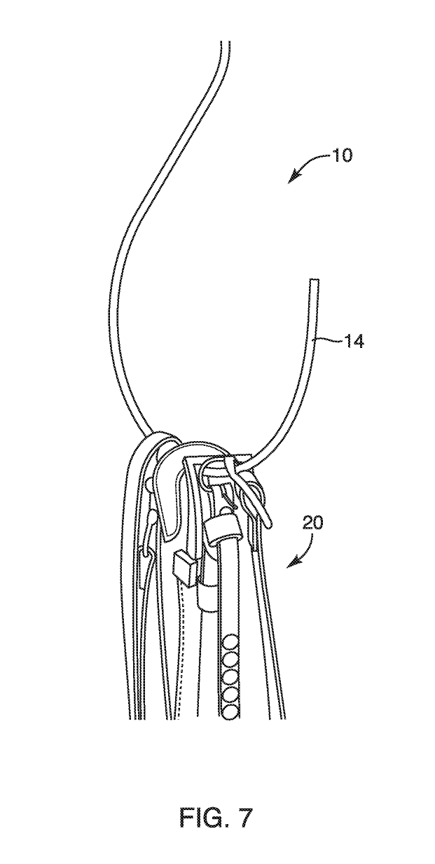

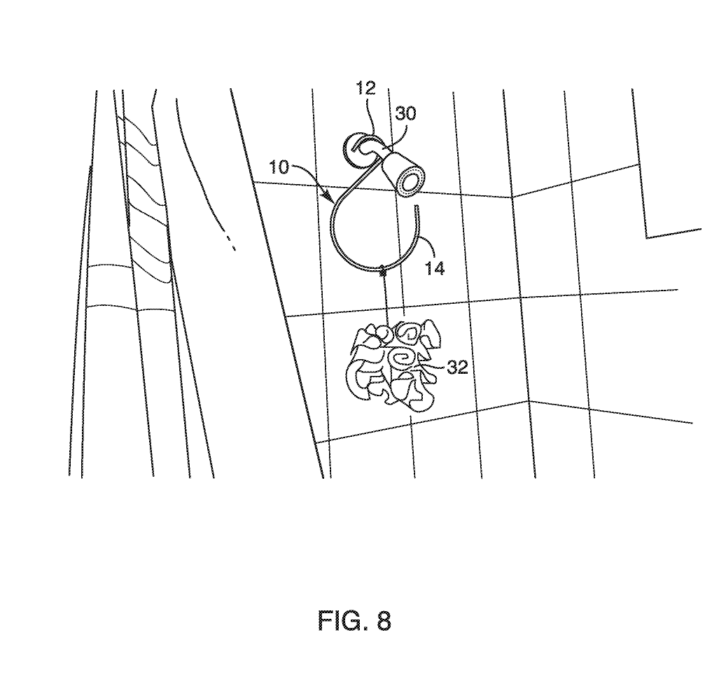

Coupling structure 12 can be attached to virtually any fixed structure. One example of a fixed structure is a closet rod (see FIG. 4). Supporting structure 14 is substantially larger than coupling structure 12 to create surface area to drape clothing, accessories, or other items thereon (see FIG. 4 and FIG. 6). Alternatively, supporting structure 14 can also accommodate closed looped items, such as belts, purses, or other closed loop items, by threading the closed loop portion of the item directly onto the bottom hook (see FIG. 4, FIG. 5, FIG. 7, and FIG. 8).

With reference now to FIG. 4, a series of organizational structures 10 are illustrated in a closet environment. Each organizational structure 10 includes a coupling structure 12 having a first radius and supporting structure 14 having a second radius. Coupling structures 12 are each configured to be selectively hung from or otherwise coupled to a fixed surface, namely the illustrated closet rod. In the illustrated embodiment, the radius of the coupling structure 12 is configured to be removably coupled to the closet rod such that it can be selectively coupled to and decoupled from the closet rod. Further, it can be used to couple to any of a variety of fixed supporting surfaces. As provided herein, some embodiments include a coupling structure having a radius that is configured to be fixedly coupled to the closet rod or other fixed surface.

Embodiments of the present invention are provided in a variety of colors to allow for the utilization of the colors to not only add aesthetic appeal, but also to be able to use the colors to coordinate or otherwise organize based on the colors. For example, each color represents a different item of clothing or accessory. Alternatively, different colors can be implemented to promote further branding opportunities such as sport franchises, universities and schools, charitable causes, etc.

In the illustrated embodiment of FIG. 4, each organizational structure 10 is supporting different items 20. For example, organizational structure 10a is supporting items 20a, which are various types of jewelry. Organizational structure 10b is supporting items 20b, which are various neckties. Organizational structure 10d is supporting items 20d, which are various light weight scarves. Organizational structure 10e is supporting items 20e, which are other scarves.

With reference now to FIG. 5, an organizational structure 10 is illustrated having a supporting structure 14 that is configured to receive a variety of items 20. In FIG. 5, organizational structure 10 has the strength to support a plurality of purses without causing organizational structure 10 to substantially deform, bend or change shape.

With reference now to FIG. 6, an organizational structure 10 is illustrated having a coupling structure 12 and a supporting structure 14, wherein the supporting structure 14 is configured to receive a variety of items 20. In FIG. 6, organizational structure 10 is supporting a variety of scarves.

With reference now to FIG. 7, an organizational structure 10 is illustrated having a supporting structure 14 that is configured to receive a variety of items 20. In FIG. 6, organizational structure 10 is supporting a variety of belts.

With reference now to FIG. 8, an organizational structure 10 is illustrated in a shower environment having a coupling structure 12 selectively coupled to the shower 30 and a supporting structure 14 that is configured to receive an item 32. In FIG. 8, organizational structure 10 is supporting a loofah.

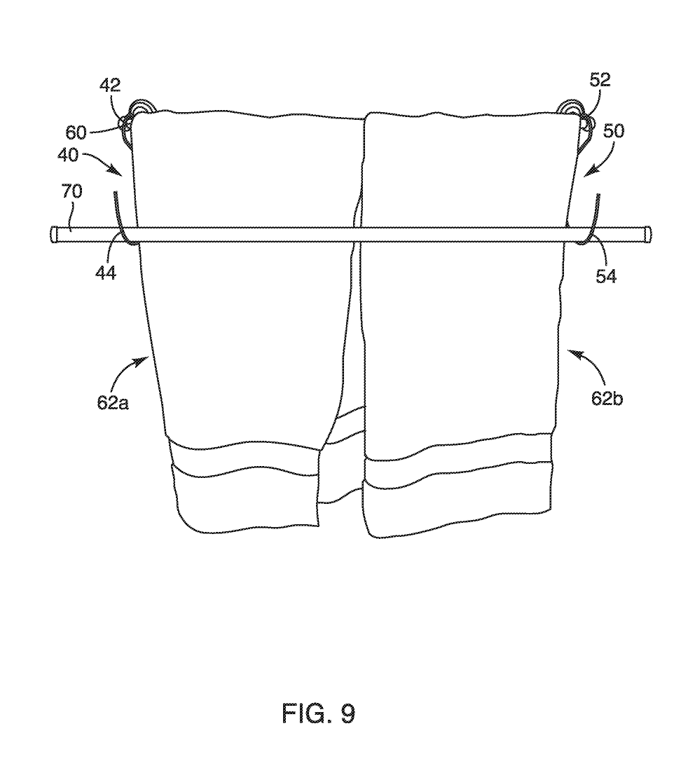

With reference now to FIG. 9, a plurality of organizational structures are illustrated to show how the organizational structures are used in a system to provide increased surface area for supporting items. In FIG. 9, organizational structure 40 comprises a coupling structure 42 and a supporting structure 44. Similarly, organizational structure 50 comprises coupling structure 52 and supporting structure 54. Coupling structures 42 and 52 are selectively coupled to fixed rod 60. A second rod 70 is coupled to supporting structures 44 and 54. Accordingly, increased surface area is provided to hang items 60. For example, items 60 can be hung or otherwise draped on rod 60 and/or on rod 70. Further, additional items can be hung from supporting structures 44 and/or 54.

In further embodiments, one or more other sets of organizational structures and corresponding rods can be selectively coupled to rod 70 to allow for increased surface area for supporting items. Thus, embodiments of the present invention embrace allowing the user to create the structure needed for the particular task and to provide the needed surface area.

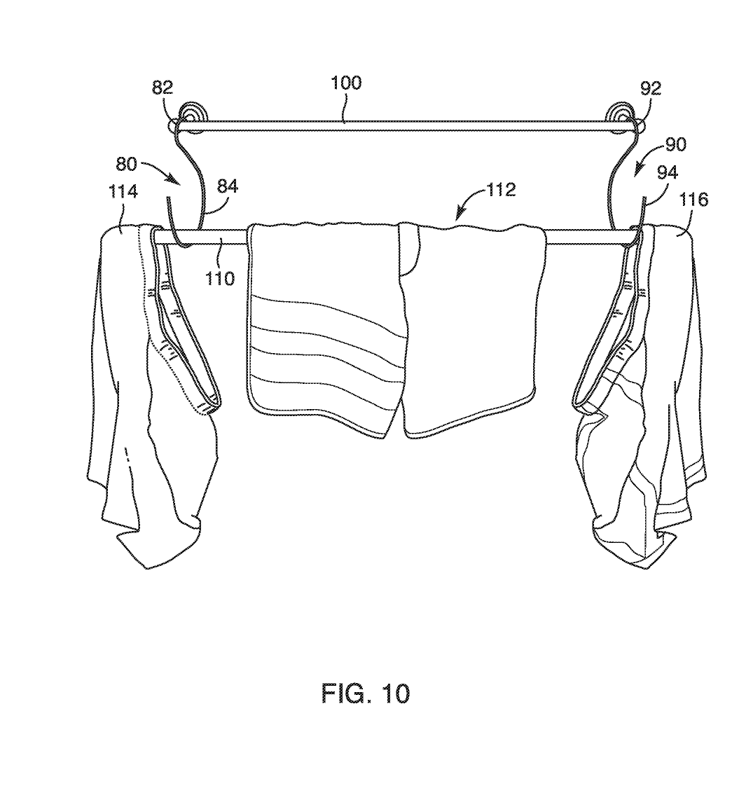

With reference to FIG. 10, another representation of a plurality of organizational structures is illustrated that provides increased surface area for supporting items. In FIG. 10, organizational structures 80 and 90 are illustrated. Organizational structure 80 comprises coupling structure 82 and supporting structure 84. Similarly, organizational structure 90 comprises coupling structure 92 and supporting structure 94. Coupling structures 82 and 92 are selectively coupled to fixed rod 100. A second rod 110 is coupled to supporting structures 84 and 94. Accordingly, increased surface area is provided to hang items 112, 114, and 116.

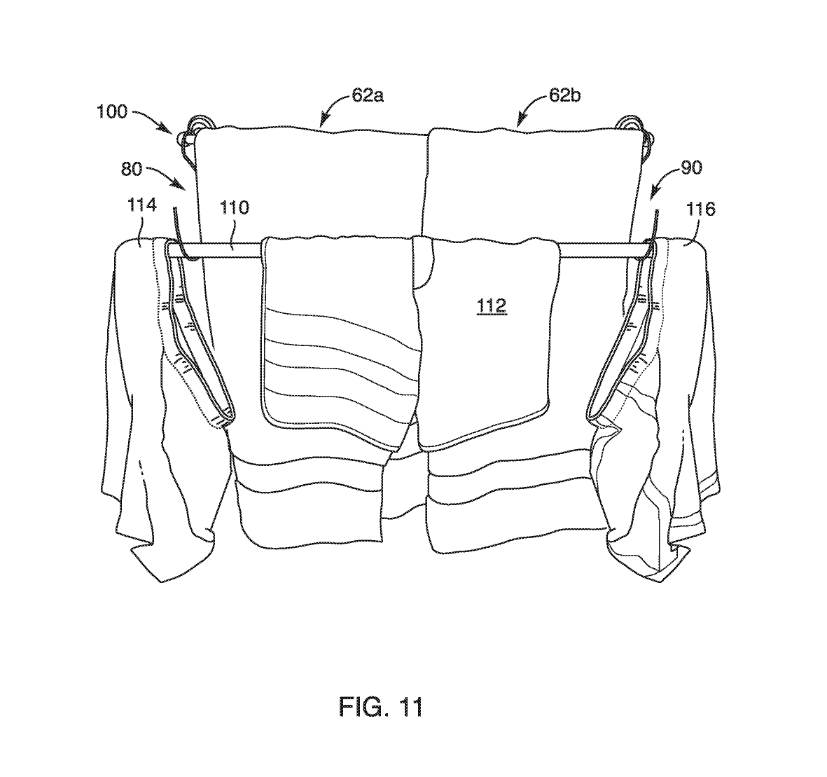

With reference to FIG. 11, organizational structures 80 and 90 of FIG. 10 are illustrated as being coupled to rod 100 and to rod 110 to provide increased surface area in order to hang 112, 114, and 116 as well as items 62a and 62b.

Thus, at least some embodiments comprise a plurality of the organizational structures that are configured to be selectively used in tandem to create further structures that maximize space and create additional surface area. Accordingly, embodiments of the present invention can be used as a single unit to hang or drape clothing, accessories, supplies, and/or other items, can be used in a series of single units to organize and store clothing, accessories, supplies, and/or other items by style, type, color, or any other organizational categorization, or can be used in a networked structure of units that optimally utilize available space.

As provided herein, at least some embodiments of the present invention are highly configurable, inexpensive, aesthetically pleasing, and versatile. In some embodiments, the organizational structure selectively receives an assortment of add-ons, attachments, and/or other additional supporting structures or surfaces that add an additional layer, attribute or feature of organization. Such attachments are generally coupled to the organizational structure, such as by being threaded onto a surface of the organization structure. Thus, add-on structures can be used to maximize efficiency and organization by including smaller individualized surface areas to hang/drape items using the main component or organizational structure while maintaining separation between the items being hung/draped.

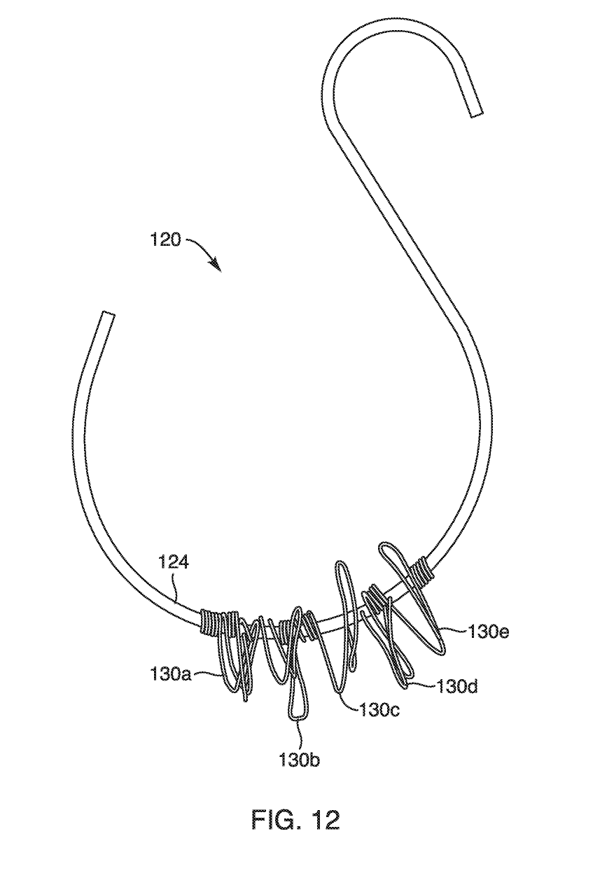

With reference to FIG. 12, an organizational structure 120 is provided having a coupling structure 122 and a supporting structure 124. In the illustrated embodiments, add-on structures 130 are coupled to supporting structure 124 by threading supporting structure through a receiving portion of add-on structures 130. Accordingly, add-on structures 130 can be used as additional surfaces for hanging items.

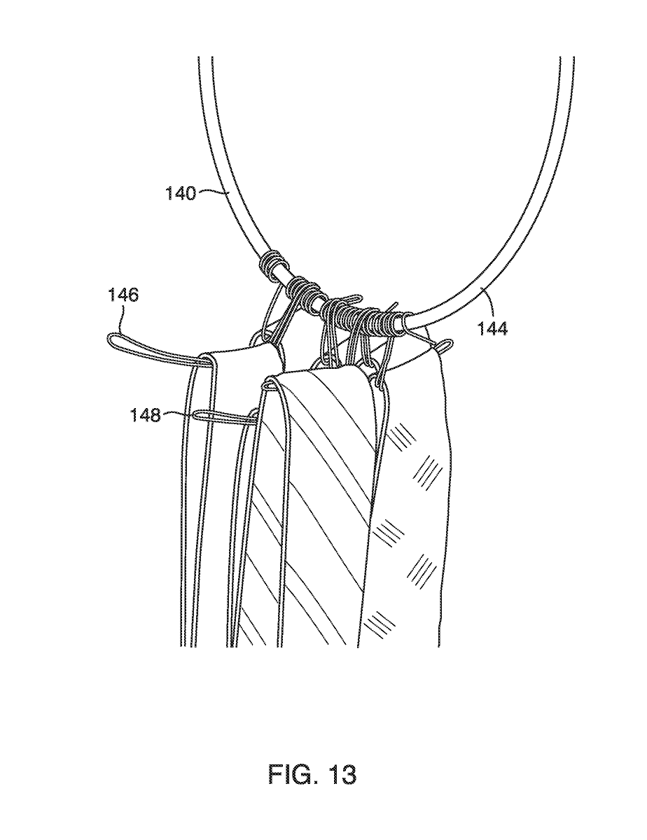

With reference now to FIG. 13, an organizational structure 140 is provided having a coupling structure (not shown) and a supporting structure 144. In the illustrated embodiments, add-on structures 146 and 148 are each coupled to supporting structure 144 by threading supporting structure through a receiving portion of add-on structures 146 and 148. Accordingly, add-on structures 146 and 148 can be used as additional surfaces for hanging items, namely each add-on structure 146 and 148 are supporting a necktie.

With reference to FIG. 14, an organizational structure 150 is provided having a coupling structure 152 and supporting structure 154. In the illustrated embodiments, add-on structures 156 are coupled to supporting structure 144 by threading supporting structure through a receiving portion of add-on structures 156. Accordingly, add-on structures 156 can be used as additional surfaces for hanging items, such as necklace 158.

At least some embodiments include one or more flat surface areas for items that can be draped (such as neckties and scarves), and/or one or more hook surface areas for closed looped items (such as belts and small purses). In some embodiments of the present invention, the coupling structure is a single ball that can be attached to a socket joint attached to a metal rod (as in hotel hangers).

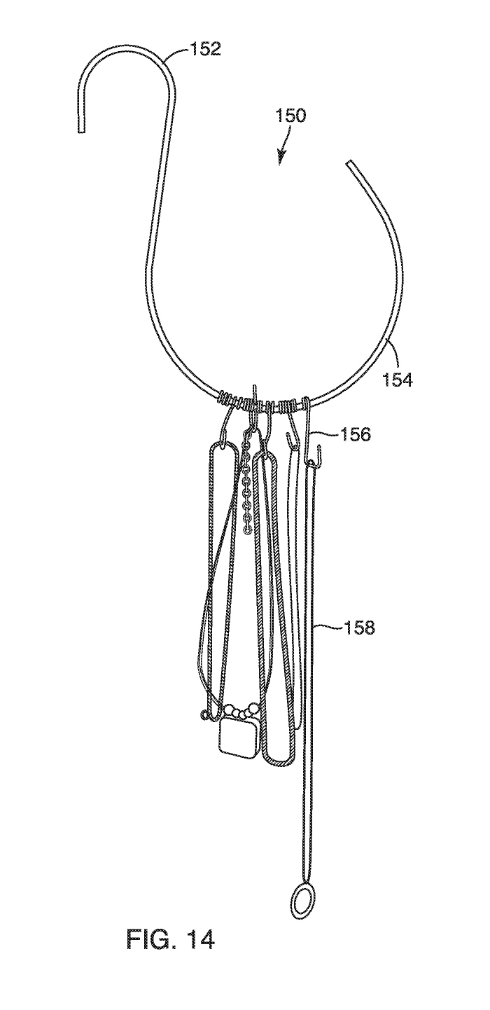

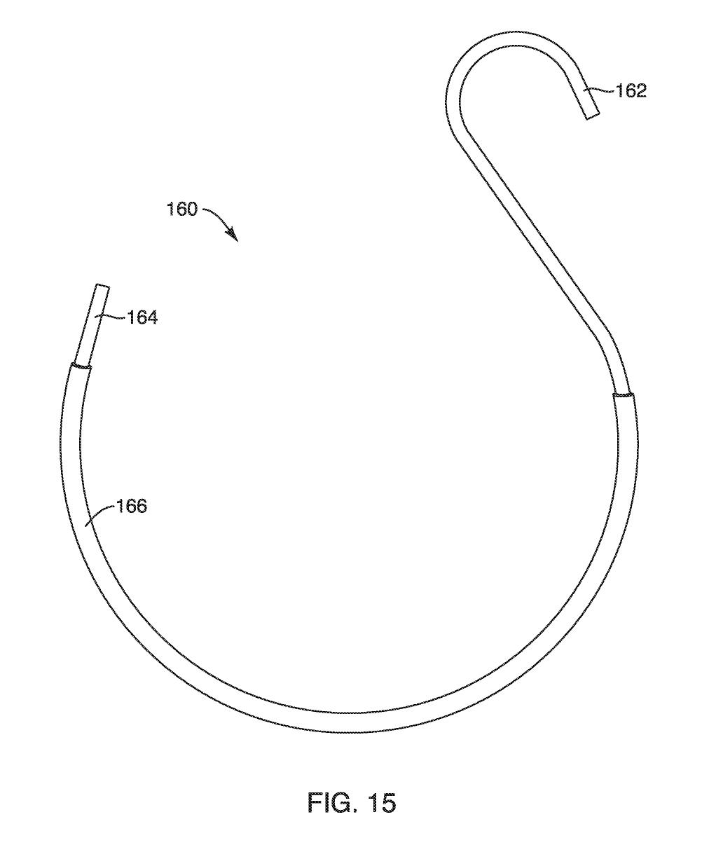

With reference now to FIG. 15, an organizational structure 160 is provided having a coupling structure 162 and a supporting structure 164. In the illustrated embodiments, add-on structure 166 is a sleeve that is coupled to supporting structure 164 by threading supporting structure through add-on structures 166. In at least some embodiments, add-on structure 166 comprises an adhesive coating, a polymer, rubber, mesh, a silicone, and/or and another material to provide an additional attribute to the organizational system. For example, add-on structure 166 comprises a polymer material to provide a cushion and/or a non-slip surface as items are hung from supporting structure 164.

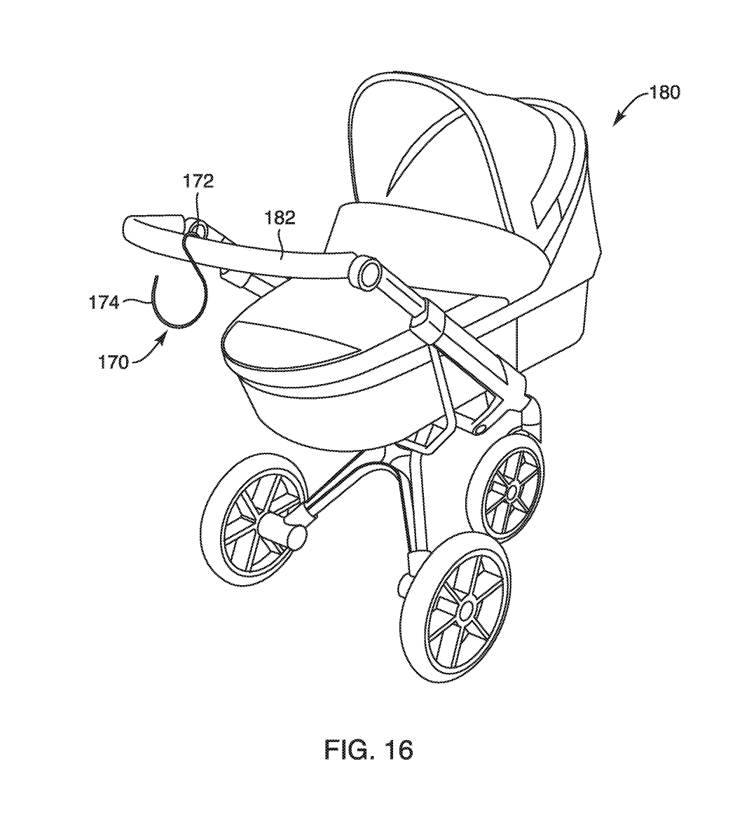

With reference now to FIG. 16, a representative organizational structure is illustrated that is used in a representative environment. In FIG. 16, organizational structure 170 is provided having a coupling structure 172 and a supporting structure 174. In the illustrated embodiment, coupling structure 172 is selectively coupled to a fixed surface, namely handle 182 of baby stroller 180. Accordingly, items such as one or more grocery bags, handbags, shopping bags, diaper bags, supplies, and/or other items can be selectively coupled to and therefore retained at supporting structure 174.

Thus, as discussed herein, the embodiments of the present invention embrace accessory organizers. In particular, embodiments of the present invention relate to systems and methods for providing a load bearing accessory organizer that is dynamic, versatile and resilient.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An organizational system comprising:
a base structure having a plurality of radii, wherein a first radius of the radii is located at a first portion of the base structure and is configured to be selectively coupled to a fixed surface, and wherein a second radius of the radii is located at a second portion of the base structure, the first portion being opposite the second portion, and wherein the second radius is configured to provide support for an item to be hung therefrom; and
an add-on structure that is selectively coupled to at least a portion of the second radius, and where the add-on structure provide an additional attribute to the organizational system.
